(19) United States
(12) Patent Application Publication
(10) Pub. No.: US 2022/0396962 A1
(43) Pub. Date: Dec. 15, 2022

(54) Earthquake Safety Protection Device

(71) Applicant: Timothy Grigsby, Atlanta, GA (US)

(72) Inventor: Timothy Grigsby, Atlanta, GA (US)

(21) Appl. No.: 17/344,017

(22) Filed: Jun. 10, 2021

(51) Int. Cl. E04H 9/02; E06B 1/52; E06B 5/10

(52) U.S. Cl. CPC E04H 9/021; E06B 1/52; E06B 5/10

(57) ABSTRACT

An article of manufacture for an earthquake safety protection device (ESPD) according to the present invention is disclosed. The ESPD consists of an earthquake support pole and mating support members to create survivable space around the support pole should a room be damaged in an earthquake. The ESPD may also comprise a reinforced frame within an interior door of a building. The reinforced frame resists damage from an earthquake that may prevent the interior door from opening. Opening or removal of the inner door protected by the reinforced frame creates a means of safely exiting a room in spite of damage to the interior door and its corresponding door frame. The ESPD may also include a mechanism to prevent a mobile hospital bed from moving about a room during an earthquake.

### CROSS-REFERENCE TO RELATED APPLICATION

This application claims priority to U.S. Provisional Patent Application No. 63/040,284, titled “Earthquake Safety Protection Device,” and filed on Jun. 17, 2020. The entire application is incorporated herein by reference in its entirety.

### TECHNICAL FIELD

This application relates in general to an article of manufacture for providing an earthquake safety protection device.

### BACKGROUND

People may become trapped within a damaged building following an earthquake. Depending upon the severity of the earthquake, significant damage may occur to a building in the earthquake zone that may result in walls and ceilings collapsing and trapping victims within the building. The damaged walls and ceilings typically fall onto individuals causing injuries. Damage to the walls and ceilings may also prevent inner doors from opening creating further obstacles to a safe escape from a damaged building.

The present invention attempts to address existing building designs according to the principles and example embodiments disclosed herein. The earthquake safety protection device attempts to create survivable space within a building that preserves areas in which people may remain unharmed from falling debris. The present invention also attempts to allow victims of an earthquake to safely exit a building with damage to interior doors that prevents the doors from opening.

### SUMMARY

In accordance with the present invention, the above and other problems are solved by providing an article of manufacture for an earthquake safety protection device (ESPD) according to the present invention. The ESPD consists of a support pole and mating support members to create survivable space around the support pole should an interior area be damaged in an earthquake. The ESPD may also comprise a reinforced frame within an interior door of a building. The reinforced frame resists damage from an earthquake that may prevent the interior door from opening. Opening or removal of the inner door protected by the reinforced frame creates a means of exiting an area in spite of damage to the interior door and its corresponding door trim. The ESPD may also include a mechanism to restrain a hospital bed from moving about a room or overturning during an earthquake.

In one embodiment, the earthquake safety protection device includes an earthquake support pole having a top end positioned about the habitable ceiling of a space and a bottom end, a plurality of support members coupled to the top end of the earthquake support poles, the plurality of support members being perpendicular to the earthquake support pole and being adjacent to the ceiling, and an anchoring mechanism coupling the bottom end of the earthquake support pole to the floor.

In other aspect of the present invention, the plurality of support members each have a pair of ends and a center point, and the plurality of support members are coupled to the earthquake support pole about the center point.

In other aspect of the present invention, the plurality of support members each have a pair of ends and a center point, and the plurality of support members are coupled to the earthquake support pole about the one of the ends of each support member.

In other aspect of the present invention, the earthquake support pole is positioned within a corner of the habitable space.

In other aspect of the present invention, the earthquake support pole further comprises a handle.

In other aspect of the present invention, the earthquake support pole is positioned about a center of the habitable space.

In other aspect of the present invention, the earthquake support pole is further coupled to a steel table having legs in contact with the floor of the habitable space.

In another embodiment, the earthquake safety protection device includes a reinforced frame about an outer edge of the interior door to the habitable space, a reinforced inner frame about an opening in the egress door, and an inner egress door within the interior egress door secured within the reinforced inner frame.

In other aspect of the present invention, the reinforced inner frame engages the reinforced frame using one or more cross members through the interior door when closed.

In other aspect of the present invention, the inner egress door has a swinging door component and a locking handle for securing the swinging door component to the reinforced inner frame.

In other aspect of the present invention, the swinging door component is coupled to the reinforced inner frame by one or more hinges opposite the locking handle.

In other aspect of the present invention, the swinging door component is coupled to the reinforced inner frame by coupling tabs opposite the locking handle permitting the removal of the swinging door component from the reinforced inner frame.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-b illustrate one potential embodiment of an article of manufacture for an earthquake safety protection device (ESPD) according to the present invention.

FIGS. 2a-b illustrate another potential embodiment of an article of manufacture for an ESPD according to the present invention.

FIG. 3 illustrates yet another potential embodiment of an article of manufacture for an ESPD according to the present invention.

FIG. 4 illustrates another potential embodiment of an article of manufacture for an ESPD according to the present invention.

### DETAILED DESCRIPTION

This application relates in general to an article of manufacture for an earthquake safety protection device (ESPD).

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes and other quantities and characteristics are not and need not be exact but may be approximated and/or larger or smaller, as desired, reflecting tolerances, conversion factors, rounding off, measurement error and the like and other factors known to those of skill. Further, unless otherwise stated, the term “about” shall expressly include “exactly.”

The terms “user” and “victim” refer to an entity, e.g., a human, who is protected by an earthquake safety protection device (ESPD) according to the present invention. In a particular case, the user is one that is located within a building or other built space during an earthquake. For such a user, the terms user and victim may be used herein interchangeably.

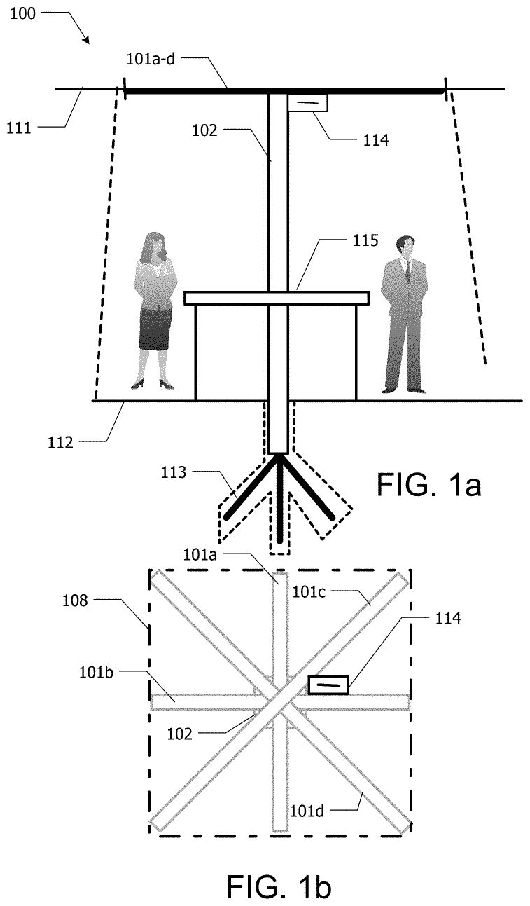

FIGS. 1a-b illustrate one potential embodiment of an article of manufacture for an earthquake safety protection device (ESPD) according to the present invention. FIG. 1a shows a front view of a living or working space in a building that uses the ESPD according to the present invention. An earthquake support pole 102 is placed between a floor 112 and a ceiling structure 111 to create survivable space 100 within a building. The earthquake support pole 102 is coupled to a plurality of support members 101a-d at the top end of the support pole. These plurality of support members 101a-d are also coupled to the ceiling structure 111.

The earthquake support pole 102 typically has dimensions that are long enough to run from a ceiling structure 111 to the floor 112. In some embodiments, the earthquake support pole 102 may be placed within a properly sized enclosure 113 of the floor 112 that possesses a horizontal member 121 and a plurality of diagonal 122a-b members with an entire anchoring mechanism being encased in concrete to provide additional support to the pole. The plurality of support members 101a-d may be coupled to the pole mechanically using fasteners such as nuts and bolts, a weld if the plurality of support members 101a-d and the earthquake support pole 102 are made of weldable metal, and other coupling techniques such as forging the pole and support members into a single structure. The plurality of support members 101a-d and the earthquake support pole 102 may be made of steel or other metals, wood, or other synthetic materials that provide sufficient strength to maintain space around the support pole when an earthquake has caused damage to the building. A toolbox 114 containing a miscellaneous tool kit, gloves, flashlight, etc. to aid individuals who may be in this area during an earthquake. The toolbox 114 is typically located near the earthquake support pole 102 near the ceiling to keep it out of the way while remaining accessible when needed.

In one embodiment, the earthquake support pole 102 may also provide an attached steel desk or tabletop 115 that is coupled to the earthquake support pole 102. The steel desk 115 may provide additional protected space underneath its top surface for people to retreat to find additional protection from falling debris.

FIG. 1b shows a top view of the plurality of support members 101a-d and the earthquake support pole 102. The plurality of support members 101a-d are arranged in a crisscross pattern and are centered about the earthquake support pole 102. This arrangement allows the plurality of support members 101a-d to create survivable space 100 around the earthquake support pole 102 should the building suffer damages. In some embodiments, a horizontal layer 108 may be coupled between the ceiling structure 111 and the plurality of support members 101a-d to help prevent debris from falling within the survivable space around the earthquake support pole 102. The horizontal layer 108 may be made of metal or wood and may be coupled to the plurality of support members 101a-d in a manner similar to how the earthquake support pole 102 is coupled to the support members.

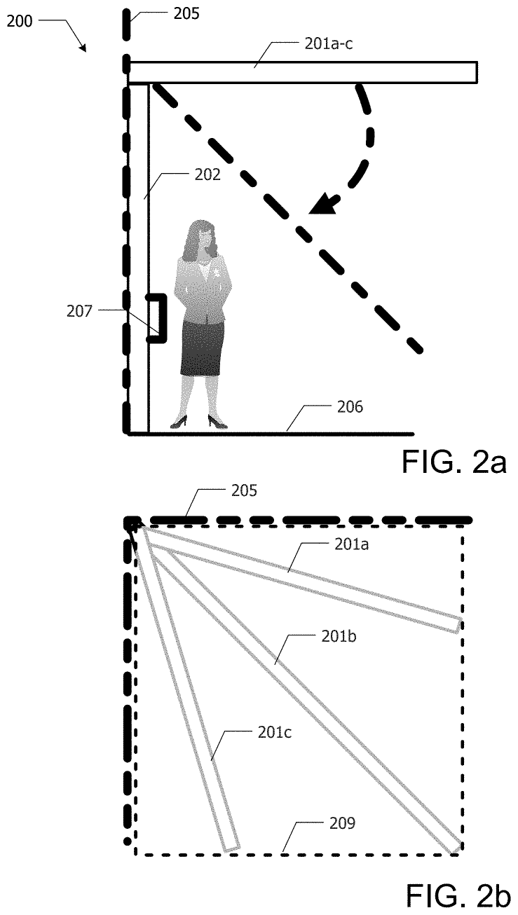

FIGS. 2a-b illustrate another potential embodiment of an article of manufacture for providing an earthquake safety protection device in a corner of space within a building according to the present invention. FIG. 2a shows a side view of a living or working space in a building that uses the earthquake safety protection device (ESPD) according to the present invention. A pair of walls 205 form a corner of a room or other space in a building in which a corner support pole 202 is located. The corner support pole 205 may be coupled to the wall and any underlying wall structures while running from the floor 206 to the corner ceiling structure 208. A plurality of corner support members 201a-c are coupled to the top of the corner support pole 202 and extend outward from the corner into the living area to create survivable space 200 underneath. The corner support pole 202 may include a victim support grip 207 that acts as a handle to support someone during an earthquake.

The corner support pole 202 typically has is long enough to run from a ceiling structure 208 to the floor 206. The plurality of corner support members 201a-d may be coupled to the pole mechanically using fasteners such as nuts and bolts, a weld if the plurality of corner support members 201a-c and the corner support pole 202 are made of weldable metal, and other coupling techniques such as forging the pole and support members into a single structure. The plurality of corner support members 201a-c and the corner support pole 202 may be made of steel or other metals, wood, or other synthetic materials that provide sufficient strength to maintain space around the support pole when an earthquake has caused damage to the building.

FIG. 2b shows a top view of the plurality of corner support members 201a-c and the corner support pole 202. The plurality of corner support members 101a-d are arranged in a fan-like pattern and are centered about the corner support pole 202. The arrangement of the plurality of corner support members 201a-c creates survivable space 200 around the corner support pole 202 should the building suffer damages. In some embodiments, a horizontal layer 209 may be coupled between the ceiling structure 208 and the plurality of corner support members 201a-c to provide additional material to prevent debris from falling within the survivable space around the corner support pole 202. The horizontal layer 209 may be made of metal or wood and may be coupled to the plurality of corner support members 201a-c in a manner similar to how the corner support pole 202 is coupled to the support members.

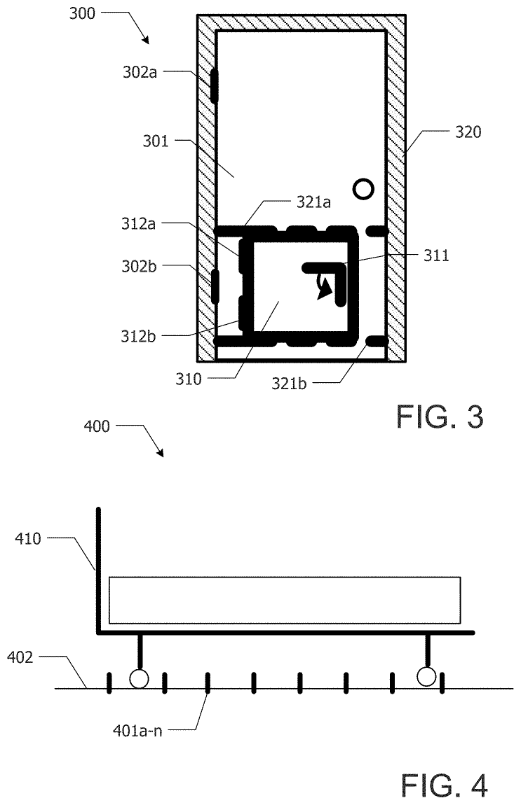

FIG. 3 illustrates yet another potential embodiment of an article of manufacture for an earthquake safety protection device (ESPD) according to the present invention. In this embodiment, an earthquake escape structure 300 is constructed within an interior door within a building. The earthquake escape structure 300 comprises an inner egress door 310 located within a reinforced inner frame 303. The reinforced inner frame 303 may be constructed of metal or wood and has a thickness to increase the likelihood that the frame will remain intact even when the interior egress door 301 and the reinforced frame 320 forming a door jamb and/or hinges 302a-b are damaged in an earthquake.

Should the space within the building around the door 301 be damaged, the interior egress door may not safely open. If victims are located within living space behind the damaged interior egress door, these victims may be trapped in the building until they can be rescued. When the interior egress door 301 contains an earthquake escape structure 300, individuals may open the inner egress door 310 and pass through the inner reinforced frame 303. The inner egress door 310 may be coupled to the reinforced inner frame 303 using hinges 312a-b and accessed by rotating a locking handle 311 within the inner door 310. In alternate embodiments, the inner door 310 may be secured within coupling tabs in place of hinges that permit the entire inner door 310 to be removed from the reinforced frame 303 once the locking handle 311 is disengaged.

The interior egress door 301 may also be enclosed in a solid steel reinforced frame 310 in order to reinforce the space containing the door 301 as well as the inner door 310 and its inner reinforced frame 303. The inner reinforced frame may be coupled to the reinforced frame 310 when the interior egress door 301 is closed by one or more cross members 321a-b.

FIG. 4 illustrates another potential embodiment of an article of manufacture for an earthquake safety protection device (ESPD) according to the present invention. Mobile beds 410 typically found in hospitals, nursing homes, and similar care facilities 400 are used by patients who may be unable to move from the bed or room without assistance. These mobile beds 410 typically possess lockable wheels that keep the bed in place in most situations, but when unlocked permit the bed and patient to be moved about the room or facility. The wheel locks on the mobile beds 410 in hospitals 400 do not prevent the bed from moving should the entire room be affected by a strong tremor or earthquake. In this embodiment, a set of earthquake safety protection devices 401a-n is located within the floor 402. These earthquake safety protection devices 401a-n secure the mobile bed 410 when locked into place preventing it from moving during an earthquake.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

1. An article of manufacture for providing for an earthquake safety protection device within a habitable space having a ceiling and a floor, the device comprises:
an earthquake support pole having a top end positioned about the habitable ceiling of a space and a bottom end;
a plurality of support members coupled to the top end of the earthquake support poles, the plurality of support members being perpendicular to the earthquake support pole and being adjacent to the ceiling; and
an anchoring mechanism coupling the bottom end of the earthquake support pole to the floor.

2. The device according to claim 1, wherein the plurality of support members each have a pair of ends and a center point; and
the plurality of support members are coupled to the earthquake support pole about the center point.

3. The device according to claim 1, wherein the plurality of support members each have a pair of ends and a center point; and
the plurality of support members are coupled to the earthquake support pole about the one of the ends of each support member.

4. The device according to claim 3, wherein the earthquake support pole is positioned within a corner of the habitable space.

5. The device according to claim 4, wherein the earthquake support pole further comprises a handle.

6. The device according to claim 2, wherein the earthquake support pole is positioned about a center of the habitable space.

7. The device according to claim 6, wherein the earthquake support pole is further coupled to a steel table having legs in contact with the floor of the habitable space.

8. An article of manufacture for providing for an earthquake safety protection device within an egress door to a habitable space having a ceiling and a floor, the device comprises:
a reinforced frame about an outer edge of the interior door to the habitable space;
a reinforced inner frame about an opening in the egress door; and
an inner egress door within the interior egress door secured within the reinforced inner frame.

9. The device according to claim 8, wherein the reinforced inner frame engages the reinforced frame using one or more cross members through the interior door when closed.

10. The device according to claim 8, wherein the inner egress door comprises:
a swinging door component; and
a locking handle for securing the swinging door component to the reinforced inner frame.

11. The device according to claim 10, wherein the swinging door component is coupled to the reinforced inner frame by one or more hinges opposite the locking handle.

12. The device according to claim 10, wherein the swinging door component is coupled to the reinforced inner frame by coupling tabs opposite the locking handle permitting the removal of the swinging door component from the reinforced inner frame.
